(19) United States
(12) Patent Application Publication
(10) Pub. No.: US 2006/0116451 A1
(43) Pub. Date: Jun. 1, 2006

(54) Stabilization of antioxidants

(76) Inventors: Bhalchandra S. Lele, Pittsburgh, PA (US); Alan J. Russell, Gibsonia, PA (US)

Correspondence Address: BARTONY & HARE, LAW & FINANCE BUILDING, SUITE 1801, 429 FOURTH AVENUE, PITTSBURGH, PA, 15219, US

(21) Appl. No.: 11/288,925

(22) Filed: Nov. 29, 2005

Related U.S. Application Data
(60) Provisional application No. 60/631,678, filed on Nov. 29, 2004.

(51) Int. Cl. C08K 5/34

(52) U.S. Cl. 524/100

(57) ABSTRACT

A composition includes at least one antioxidant moiety and at least one UV-absorbing moiety. The antioxidant moiety and the UV-absorbing moiety are maintained in proximity to each other. The UV-absorbing moiety and the antioxidant moiety can, for example, be attached to a common entity. The antioxidant moiety and the UV-absorbing moiety can, for example, be covalently attached within a single molecule. The UV-absorbing moiety can be attached sufficiently closely to the antioxidant moiety to enhance the stability of the antioxidant in an environment in which photooxidation can occur. In one embodiment, the UV-absorbing moiety is attached to the molecule to be juxtapositioned to the antioxidant moiety.

### CROSS-REFERENCE TO RELATED APPLICATION

This application claims the benefit of U.S. Provisional Patent Application Ser. No. 60/631,678, filed Nov. 29, 2004, the disclosure of which is incorporated herein by reference.

### GOVERNMENT INTEREST

This invention was made with government support under grant DAAD: 19-01-0619 awarded by the Department of Defense. The government has certain rights in this invention.

### BACKGROUND OF THE INVENTION

The present invention relates generally to stabilization of antioxidants and particularly to compositions and methods in which at least one antioxidant moiety and at least one UV-absorbing moiety are co-localized to enhance the stability of the antioxidant moiety in an environment in which photooxidation can occur.

Interest in combining the photocatalytic activity of titanium dioxide (TiO₂) and the biocatalytic activity of enzymes is growing. See, for example, Takashi, S.; Ryota, S.; Mikako, K.; Mayu, K.; Hirotaka, I.; Katsutoshi, O. Chem. Comm. 2004, 814-815; Ganadu, M. L.; Andreotti, L.; Vitali, I.; Maldotti, A.; Molinari, A.; Mura, G. M. Photochem. Photobiol. Sci. 2002, 1, 951-954; and Cuendet, P.; Grätzel, M.; Pélaprat, M. L. J. Electroanal. Chem. 1984, 173-185, the disclosures of which are incorporated herein by reference. Anatase type TiO₂ absorbs ultraviolet radiation (UV) having energy greater than its optical band gap of 3.2 eV and generates an electron-hole pair. Sandola, F. In Photocatalysis—Fundamentals and applications. Serpone, N.; Pelizzetti, E. Eds.; John Wiley and Sons: New York, 1989, pp 9-44, the disclosure of which is incorporated herein by reference. Interestingly, proteins are adsorbed onto TiO₂ via electrostatic interactions. See, for example, Klinger, A.; Steinberg, D.; Kohavi, D.; Sela, M. N. J. Biomed. Mater. Sci. 1991, 36, 387-392; Topoglidis, E.; Cass, A. E. G.; Gilardi, G.; Sadeghi, S.; Beaumont, N.; Durrant, J. R. Anal. Chem. 1998, 70, 5111-5113; and Topoglidis, E.; Campbell, C. J.; Cass, A. E. G.; Durrant, J. R. Langmuir 2001, 17, 7899-7906, the disclosure of which are incorporated herein by reference. Enzyme-TiO₂ “bio-inorganic hybrids” are being investigated for enhanced performance in catalysis and sensing. The interplay between TiO₂ and the enzyme can have effects on electron transfer rates in some active sites. For example, in the presence of photoexcited TiO₂, glucose oxidase exhibits a five-fold rate enhancement in the reduction of oxygen to hydrogen peroxide. Takashi, S.; Ryota, S.; Mikako, K.; Mayu, K.; Hirotaka, I.; Katsutoshi, O. Chem. Comm. 2004, 814-815. Horseradish peroxidase-TiO₂ deposited on an electrode exhibited high rates of electron transfer from the enzyme to the electrode. Ganadu, M. L.; Andreotti, L.; Vitali, I.; Maldotti, A.; Molinari, A.; Mura, G. M. Photochem. Photobiol. Sci. 2002, 1, 951-954, the disclosure of which is incorporate herein by referenc. Nicotinamide adenine dinucleotide (NAD⁺) has been efficiently reduced to NADH by lipoamide dehydrogenase in the presence of viologen and TiO₂-UV. Cuendet, P.; Grätzel, M.; Pélaprat, M. L. J. Electroanal. Chem. 1984, 173-185, the disclosure of which is incorporate herein by reference.

Enzyme-TiO₂-UV systems are also being considered for use in decontamination since the free radicals released by TiO₂ in the presence of UV-light exhibit bactericidal and fungicidal activity. See, Ibáñez, J. A.; Litter, M. I.; Pizarro, R. A. J. Photochem. Photobiol. A: Chem. 2003, 157, 81-85 and Wolfrum, E. J.; Huang, J.; Blake, D. M.; Maness, P-C., Huang, Z.; Fiest, J. Environ. Sci. Technol. 2002, 36, 3412-3419, the disclosures of which are incorporated herein by reference. Enzymes such as diisopropylfluorophosphatase and organophosphorous hydrolase degrade active nerve agents. See, for example, Drevon G. F.; Karsten, D.; Federspiel, W.; Stolz, D. B.; Wicks, D. A.; Yu, P. C.; Russell, A. J. Biotechnol. Bioeng. 2002, 79, 785-794 and LeJeune, K. E.; Mesiano, A. J.; Bower, S. B.; Grimsley, J. K.; Wild, J. R.; Russell, A. J. Biotechnol. Bioeng. 1997, 54, 105-114, the disclosures of which are incorporated herein by reference. Thus, biocatalytic activity can be combined with photocatalytic activity to develop protective coatings against wide range of chemical and biological agents. All these novel applications suffer from the problem of rapid inactivation of proteins and nucleic acids by the hydroxyl and superoxide radicals produced on the surface of photoexcited TiO₂. See, for example, Hancock-Chen, T.; Scaiano, J. C. J. Photochem. Photobiol. B: Biol. 2000, 57, 193-196 and Wamer, W. G.; Yin, J-J.; Wei, R. R. Free Rad. Bio. Chem. 1997, 6, 851-858, the disclosures of which are incorporated herein by reference. Covalent modification of enzymes with polymeric stabilizers could protect the enzyme without affecting bulk TiO₂ activity. Indeed, covalent attachment of poly(ethylene glycol) (PEG) chains to proteins imparts steric stabilization against heat, pH and other deteriorating conditions. Poly(ethylene glycol) Chemistry: Biotechnical and Biomedical Applications. Harris, M. J. Ed. Plenum, New York, 1992, the disclosure of which is incorporated herein by reference. In the case of photooxidation, a UV-absorber and/or an antioxidant based polymer could stabilize the enzyme more efficiently than via PEGylation since PEG can be readily oxidized.

The stabilization of a model enzyme, chymotrypsin, against inactivation caused by TiO₂-UV was recently described. Lele, B. S.; Russell, A. J. Biomacromolecules 2004, 5, 1947-1955, the disclosure of which is incorporated herein by reference. Conjugating the enzyme with UV-absorbing moieties, such as carboxyl terminated oligo(2-[3-(2H-benzotriazol-2-yl)-4-hydroxyphenyl]ethyl methacrylate) (oligo(HBMA)-COOH) reduced the rate of inactivation. Chymotrypsin-oligo(HBMA) conjugates (adsorbed on irradiated TiO₂) were stabilized because of the ability of HBMA moieties to compete with TiO₂ for the UV light thereby reducing the excitation of TiO₂ in the region of HBMA. However, upon continuous irradiation, the modified enzyme deactivated gradually because of the photooxidation of both HBMA and the enzyme by the free radicals. It is interesting to note that HBMA moieties did not absorb free radicals. Thus, the enzyme protection was derived solely from the reduction in the excitation of TiO₂.

It remains desirable to develop improved compositions and method for the stabilizations of antioxidants and for the stabilization of enzymes.

### SUMMARY OF THE INVENTION

Antioxidants (also sometimes referred to as free radical absorbers) sacrificially stabilize materials against free radicals (for example, free radicals generated from photooxidation as a result of exposure to sunlight). In the present invention, compositions, systems and methods for stabilization of an antioxidant against photooxidation are provided wherein an antioxidant is localized or co-localized with an ultraviolet-absorber (“UV-absorber”). As used herein the terms “localized” or “co-localized” refer to maintaining the antioxidant and the UV-absorber in relatively close proximity to each other (in volumetric space). The antioxidant and the UV-absorber are maintained in sufficiently close proximity such that a synergistic effect on stability is achieved. In that regard, the UV-absorbing moiety can be maintained in sufficiently close proximity to the antioxidant moiety to enhance the stability of the antioxidant in an environment in which photooxidation can occur. Such localization or co-localization does not occur upon mere physical mixing of antioxidant and UV-absorber. The compositions and methods of the present invention thus provide enhanced stability as compared to compositions in which antioxidant and UV-absorber are merely physically mixed.

For example, the antioxidant can be localized with a UV-absorber within a single molecule (for example, within a single oligomeric or polymer chain). The antioxidant and the UV-absorber can, for example, be localized via covalent bonding in a reaction (for example, a copolymerization) of at least one monomer including or incorporating the antioxidant and at least one monomer including or incorporating the UV-absorber. Antioxidants and UV-absorbers can also be conjugated to a reactive polymer. The synergistic stabilization effects achieved in the present invention are useful in virtually any composition, system or process in which antioxidants are used, including, but not limited to: polymer stabilization, cosmetic and sun-screen additives, surface stabilizations, and enzyme stabilizations (including enzymatic sensor stabilizations). The compositions of the present invention can be mixed into such a composition or attached (via, for example, covalently bonding) to one or more components of the composition.

Without limitation of the present invention to any particular mechanism of operation, in a possible mechanism of operation of the present invention, localization or co-localization of a UV-absorber and a free radical absorber causes a decrease in concentration of inactivating species around the antioxidant and increases its life under photooxidizing conditions. Once again, such stabilization is not achieved by using physical mixtures of UV-absorber and antioxidant.

In one aspect, the present invention provides a composition including at least one antioxidant moiety and at least one UV-absorbing moiety. The antioxidant moiety and the UV-absorbing moiety are maintained in proximity to each other. The UV-absorbing moiety and the antioxidant moiety can, for example, be attached to a common entity. The antioxidant moiety and the UV-absorbing moiety can, for example, be covalently attached within a single molecule. The UV-absorbing moiety can be attached sufficiently closely to the antioxidant moiety to enhance the stability of the antioxidant in an environment in which photooxidation can occur. In one embodiment, the UV-absorbing moiety is attached to the molecule to be juxtapositioned to the antioxidant moiety.

The UV-absorbing moiety and the antioxidant moiety can, for example, be attached to a single polymeric chain. The polymeric chain can be formed by reaction of at least a first monomer incorporating the UV-absorbing moiety and a second monomer incorporating the antioxidant moiety. The polymeric chain can also be formed by reacting a polymeric precursor with a first compound incorporating the UV-absorbing moiety and a second compound incorporating the antioxidant moiety.

The compositions of the present invention can be added to a material to stabilize the material. For example, the composition physically mixed with the material or attached to the material. In one embodiment, a single molecule including the antioxidant moiety and the UV-absorbing moiety is covalently attached to the material. The material can be virtually any material, including for example, be a polymeric material, a cosmetic, a sun screen, a protein or an enzyme. The enzyme can, for example, be supported on a free radical producing support. In one embodiment, the support includes at least one species which is a photocatalytic oxidant. In one embodiment, the enzyme is adsorbed on a particle of titanium dioxide.

In another aspect, the present invention provides an enzyme having attached thereto at least one group including at least one antioxidant moiety and at least one UV-absorbing moiety, each of which is attached to the group. In one embodiment, the group is covalently attached to the enzyme. The antioxidant moiety and the UV-absorbing moiety can, for example, be covalently attached to the group. The UV-absorbing moiety can be attached sufficiently closely to the antioxidant moiety to enhance the stability of the antioxidant in an environment in which photooxidation can occur. The UV-absorbing moiety can, for example, be attached to be juxtapositioned to the antioxidant moiety.

In one embodiment, the UV-absorbing moiety and the antioxidant moiety are attached to a single polymeric chain. A precursor to the polymeric chain can be formed by reaction of at least a first monomer incorporating the UV-absorbing moiety and a second monomer incorporating the antioxidant moiety. A precursor to the polymeric chain can also formed by reacting a polymeric precursor with a first compound incorporating the UV-absorbing moiety and a second compound incorporating the antioxidant moiety.

In a further aspect, the present invention provides a composition including an enzyme supported on a free radical producing support. The enzyme has attached thereto at least one group comprising at least one antioxidant moiety and at least one UV-absorbing moiety as described above. The support can, for example, include at least one species which is a photocatalytic oxidant. In one embodiment, the enzyme is adsorbed on a particle of titanium dioxide.

In another aspect, the present invention provides a composition including at least one antioxidant moiety and at least one UV-absorbing moiety wherein the antioxidant moiety and the UV-absorbing moiety are tethered to be localized. The UV-absorbing moiety can be tethered sufficiently closely to the antioxidant moiety to enhance the stability of the antioxidant in an environment in which photooxidation can occur. The UV-absorbing moiety can, for example, be tethered to the antioxidant moiety by attachment of the UV-absorbing moiety and the antioxidant moiety to a molecule as described above. The UV-absorbing moiety can also, be tethered to the antioxidant moiety by attachment to a common support.

In a further aspect, the present invention provides a method of stabilizing an antioxidant moiety including the step maintaining at least one antioxidant moiety and at least one UV-absorbing moiety sufficiently closely to enhance the stability of the antioxidant moiety in an environment in which photooxidation can occur. In one embodiment, the at least one antioxidant moiety and at least one UV-absorbing moiety are attached to a common entity to enhance the stability of the antioxidant moiety in an environment in which photooxidation can occur. The antioxidant moiety and the UV-absorbing moiety can, for example, be covalently attached to a single molecule. The UV-absorbing moiety can be attached to the molecule to be juxtapositioned to the antioxidant moiety. In one embodiment, the UV-absorbing moiety and the antioxidant moiety are attached to a single polymeric chain. The polymeric chain can be formed by reaction of at least a first monomer incorporating the UV-absorbing moiety and a second monomer incorporating the antioxidant moiety. The polymeric chain can also be formed by reacting a polymeric precursor with a first compound incorporating the UV-absorbing moiety and a second compound incorporating the antioxidant moiety.

In another aspect, the present invention provides a method of synthesis of a polymer including antioxidant and UV-absorber including the step of copolymerizing polymerizable antioxidants and polymerizable UV-absorbers.

In another aspect, the present invention provides a method of synthesis of a polymer including antioxidant and UV-absorber including the step of conjugating antioxidants and UV-absorbers to a reactive polymer.

In a further aspect, the present invention provides a composition including at least one antioxidant moiety and at least one UV-absorbing moiety. The antioxidant moiety and the UV-absorbing moiety are covalently attached within a single molecule wherein the UV-absorbing moiety is attached sufficiently closely to the antioxidant moiety to enhance the stability of the antioxidant in an environment in which photooxidation can occur.

In still a further aspect, the present invention provides a method of adding an antioxidant to a material including the step of adding to the composition an antioxidant composition including at least one antioxidant moiety and at least one UV-absorbing moiety. The antioxidant moiety and the UV-absorbing moiety are covalently attached within a single molecule, wherein the UV-absorbing moiety is attached sufficiently closely to the antioxidant moiety to enhance the stability of the antioxidant in an environment in which photooxidation can occur. The antioxidant composition can, for example, be mixed into the material. The antioxidant composition can also be attached to a component of the material. In one embodiment, the antioxidant composition is covalently bonded to the component of the material.

Antioxidants and UV-absorbers can be co-localized in a wide variety of polymers in the present invention. For example, various types of vinyl polymer backbones are suitable. Moreover, poly(acrylate)s, poly(methacrylate)s, poly(acrylamide)s, poly(methacrylamide)s, poly(allylic)s and other polymers are also suitable.

Polymerizable antioxidant and UV-absorbers can, for example, be prepared by conjugation reaction between functional monomers such as 2-hydroethyl methacrylate, 2-amioethyl methacrylate, 3-aminopropyl methacrylamide, UV absorber and antioxidant. Moreover, chain-end-functionalized co-oligomers of UV-absorber and antioxidant can, for example, be conjugated to high molecular weight reactive polymers such of poly(N-acryloxysuccinimide), poly(N-methacryloyloxysuccinimide), or poly(2-hydroxyethyl methacrylate).

As used herein, the terms “polymer” or “polymeric” refer to a compound or group having multiple repeat units (or monomer units) and includes the term “oligomer,” which is a polymer that has only a few repeat units (for example, dimer, trimer etc.). The term polymer also includes copolymers which are polymers including two or more dissimilar repeat units (including terpolymers—comprising three dissimilar repeat units—etc.).

A broad variety of antioxidants can be used in the present invention. In addition to other antioxidants described herein, various plasma antioxidants such as ascorbic acid, alpha tocopherol, glutathione, and uric acid can, for example, be stabilized. Other classes of antioxidants that can be stabilized include, but are not limited to, carotenoids (for example, beta carotene and lycopene); flavanones (for example, cyanidin, catachin, naringenin, malvidin, delphinidin, and anthocyanidin); flavon-3-ols (for example, quecetin and kaempferol); hydroxycinnamates (for example, ferulic acid, p-coumaric acid, and caffeic acid). Synthetic antioxidants that can be stabilized include, but are not limited to, various tert-butyl phenols and catachols.

Likewise, a broad variety of UV absorbers are suitable for use in the present invention. In addition to other UV absorbers described herein, UV-absorbers that can be used to stabilize antioxidants in the present invention include, but are not limited to, functionalized derivatives of triazine, benzophenone, and hindered aromatic amines.

The present invention, along with the attributes and attendant advantages thereof, will best be appreciated and understood in view of the following detailed description taken in conjunction with the accompanying drawings.

### BRIEF DESCRIPTION OF THE DRAWINGS

FIG. 1A illustrates a hypothesized representation of the mechanism of deactivation of enzyme and antioxidant in the case of modified chymotrypsins against TiO₂-UV when the UV-absorber and antioxidant are not co-localized.

FIG. 1B illustrates a hypothesized representation of the mechanism of enhanced stabilization of modified chymotrypsins against TiO₂-UV as a result of the co-localization of the UV-absorber and antioxidant within a single chain.

FIG. 2A illustrates an ESI-APCI mass spectrum of oligo(HBMA)-COOH.

FIG. 2B illustrates an ESI-APCI mass spectrum of oligo(HBMA-co-Trolox-HEMA)-COOH.

FIG. 3A illustrates a MALDI-TOF spectra of native chymotrypsin.

FIG. 3B illustrates a MALDI-TOF spectra chymotrypsin-oligo(HBMA).

FIG. 3C illustrates a MALDI-TOF spectra of CTM-separate (chymotrypsin modified at separate positions on the enzyme).

FIG. 3D illustrates a MALDI-TOF spectra of CTM-single (chymotrypsin modified with HBMA and Trolox within a single chain attached to the enzyme).

FIG. 4 illustrates a schematic representation of the synthetic strategies used to obtain enzyme modifications.

FIG. 5A illustrates the effect of conjugated modifiers on the stability of chymotrypsins exposed to TiO₂-UV wherein the data reported are average of duplicate experiments.

FIG. 5B illustrates the stabilization of Trolox activity in single-chain modified enzyme upon exposure to TiO₂-UV.

FIG. 6 illustrates the retention of antioxidant activity by Trolox upon exposure to TiO₂-UV in the presence or absence of adjacent UV-absorber wherein the data reported are average of duplicate experiments.

FIG. 7A illustrates CD spectra of native chymotrypsin.

FIG. 7B illustrates CD spectra of CTM-separate.

FIG. 7C illustrates CD spectra of CTM-single.

### DETAILED DESCRIPTION OF THE INVENTION

The use of enzymes in conjunction with inorganic photocatalysts requires stability against photooxidation. In several studies of the present invention, a representative example of an enzyme is modified by covalent attachment thereto of a polymeric (oligomeric) adduct incorporating a UV-absorbing moiety and an antioxidant moiety. In that regard, we describe enhanced stabilization of a model material (the enzyme, chymotrypsin) to photooxidation driven by titanium dioxide exposed to ultraviolet light (TiO₂-UV). Stabilization is achieved by conjugating the enzyme with an oligomeric adduct of UV-absorbing (2-[3-(2H-benzotriazol-2-yl)-4-hydroxyphenyl]ethyl methacrylate) (HBMA) and free radical-absorbing 2-methacryloyloxyethyl-6-hydroxy-2,5,7,8-tetramethylchroman-2-carboxylate (TROLOX®-HEMA). Juxtaposition or co-localization of the antioxidant Trolox (vailable from Hoffmann-La Roche Inc. of Nutley, N.J.) with the UV-absorber HBMA (for example, within a single chain) reduced the rate of deactivation of the former by TiO₂-UV. This modification enables modified enzyme, which is adsorbed on TiO₂, to absorb both UV-light and free radicals and locally reduce the rate of photooxidation. Interestingly, Trolox was more readily deactivated by TiO₂-UV when it was conjugated separately to chymotrypsin that had been pre-modified with HBMA moieties.

One skilled in the art appreciates that the stabilization of antioxidants in materials demonstrated in the studies of the present invention is not limited to the representative proteins (for example, enzymes) set forth herein. Indeed, the co-localization of an antioxidant moiety and a UV-absorbing moiety of the present invention can be used to enhance the stability of virtually any type of material. The compositions of the present invention (in which an antioxidant moiety and a UV-absorbing moiety are co-localized) can, for example, be physically mixed with a composition or attached to a composition (for example, via covalent bonding) to enhance the stability thereof against photooxidation. Examples of compositions or materials which can be stabilized by the compositions of the present invention include, but are not limited to, polymers (both synthetic polymers and biopolymers such as proteins or enzymes), cosmetics, sun screens, surface treatments and colorants.

Given the strong oxidizing activity of TiO₂-UV it was hypothesized that the antioxidant (which is basically an organic compound) might be more accessible for photooxidation when randomly conjugated to the enzyme. Conversely, by juxtapositioning the antioxidant with a UV-absorber there was a possibility that the enzyme could be protected from inactivation by maximizing the removal of free radicals. In the studies of the present invention, a two-fold enhancement in the stability of the modified enzyme against TiO₂-UV was achieved by conjugating the native enzyme with an oligomeric adduct of UV-absorbing HBMA and a polymerizable derivative of Trolox, the free radical absorbing chroman ring in the antioxidant vitamin E. We demonstrated that TiO₂-UV caused significant loss in the antioxidant activity of Trolox when it is randomly conjugated with the enzyme pre-modified with oligo(HBMA) chains. However, the antioxidant activity of Trolox was stabilized for a significantly longer duration (as was the enzyme activity), when Trolox and HBMA were co-localized within a single chain attached to the enzyme.

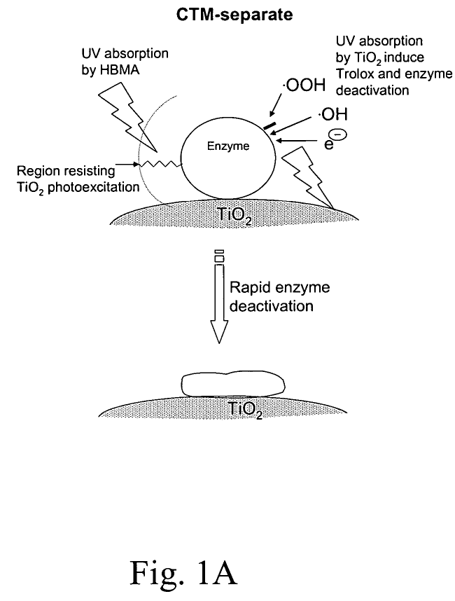

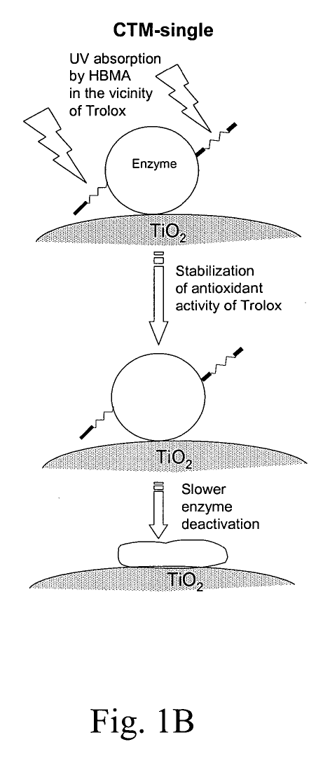

Two types of chymotrypsin conjugates were studied to assess the interaction between Trolox and HBMA in the positioning strategy of the present invention. First, chymotrypsin was modified with oligo(HBMA)-COOH and Trolox in a stepwise manner so that the UV-absorber and the antioxidant were attached at separate locations on the enzyme. We designate the chymotrypsin modified at separate positions on the enzyme, “CTM-separate”. In the second conjugate, chymotrypsin was modified with the carboxyl functionalized co-oligomer, ensuring the presence of HBMA and Trolox within a single chain attached to the enzyme. We deisgnate this modified enzyme, “CTM-single”. Schematic representations of the two enzyme-conjugates and their hypothesized stabilizing effects against photooxidation are shown in FIGS. 1A and 1B.

To assess the impact of co-localization of a UV-absorber and an antioxidant on the stability of the enzyme, first we synthesized a reactive copolymer that included the two stabilizers within a single chain. Trolox was chosen as an antioxidant because of its well known ability to absorb free radicals and the availability of carboxyl group in its structure for covalent modifications. See, for example, Wu, T. W.; Pristupa, Z. B; Zeng, L. H.; Au, J. X.; Wu, J.; Sugiyama, H.; Carey, D. Hepatology 1992, 15, 454-458, the disclosure of which is incorporated herein by reference. We synthesized polymerizable Trolox-HEMA by a condensation reaction between the hydroxyl group in HEMA and the carboxyl group in Trolox. Then, ACV-initiated co-oligomerization of HBMA and Trolox-HEMA was used to obtain an enzyme-reactive low molecular weight product, which was soluble in water-dioxane binary solvent mixtures.

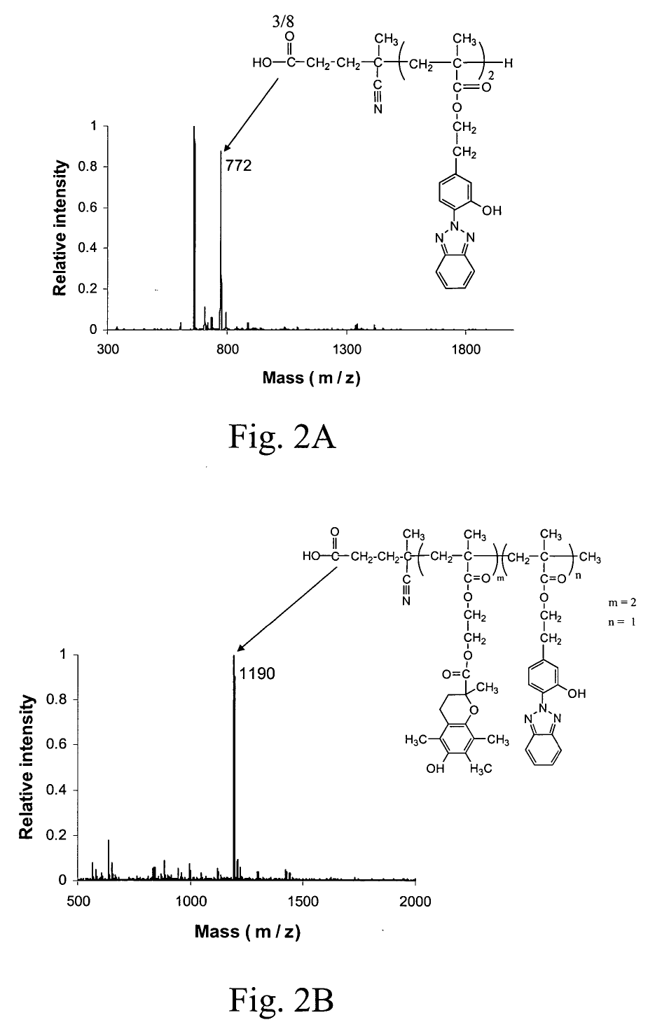

Oligo(HBMA)-COOH was synthesized as described previously in Lele, B. S.; Russell, A. J. Biomacromolecules 2004, 5, 1947-1955. ESI/APCI mass spectrometric characterization showed the formation of an approximately 60:40 mixture of two oligomers having molecular weights 662 and 772 Da, respectively (FIG. 2A). The peak at 772 can be assigned to the dimer of HBMA formed by the oligomerization initiated with C(CH₃)(CN)—CH₂—CH₂—COOH. The peak at 662 can be assigned to the dimer of HBMA formed by the oligomerization initiated with methyl radical, which was probably generated from the decomposition of the initiator. This latter oligomer has no reactive end group and can be filtered out after the enzyme-conjugation reaction. The oligo(HBMA)-COOH mixture was NHS-activated and used to modify chymotrypsin.

Oligo(HBMA-co-Trolox-HEMA)-COOH was synthesized by ACV-initiated co-oligomerization of HBMA and Trolox-HEMA. Copolymerization of two or more monomers can result in the formation of compositionally different mixtures of individual polymer chains. Surprisingly, the mass spectrum of our co-oligomer showed formation of only one major product having molecular weight of 1190 Da (FIG. 2 (b)). Successful co-oligomerization was confirmed from ¹H-NMR spectrum of the product. The Trolox to HBMA ratio was found to be 2:1 from the ratio of the number of protons in the peaks at 2.0 δ (characteristic to —CH₃ substituted phenol moiety in Trolox) and at 7.0-8.0 δ (characteristic to aromatic moiety in HBMA). The co-oligomer was activated with NHS and used to modify chymotrypsin.

When native chymotrypsin was reacted first with Trolox-NHS ester and purified, we observed via MALDI-TOF formation of a 50/50 mixture of chymotrypsin-Trolox and unmodified chymotrypsin. Interestingly, the reaction of native chymotrypsin with oligo(HBMA)-COONHS always resulted in complete modification of the native enzyme. Therefore, in our conjugate designs, we first modified the enzyme with oligo(HBMA) and then with Trolox.

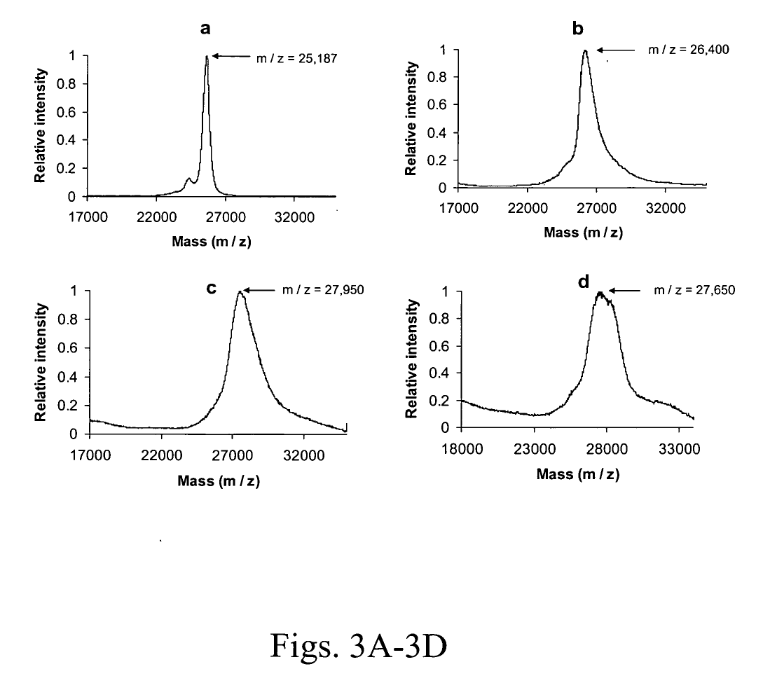

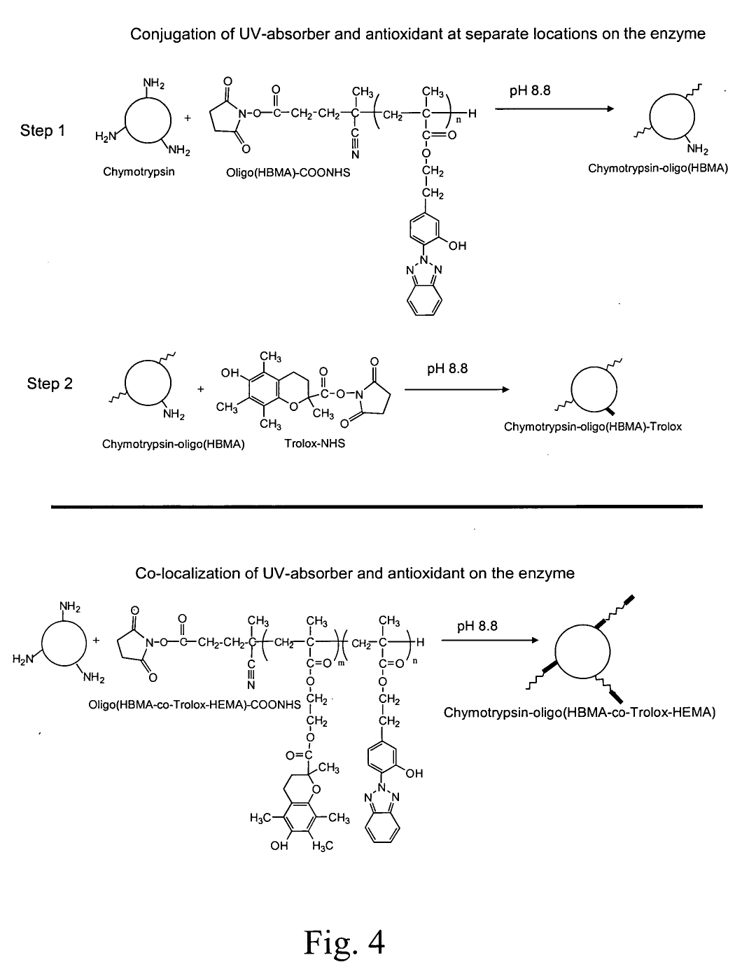

As shown in the FIG. 1A, CTM-separate is the conjugate in which chymotrypsin is modified with a UV-absorber and an antioxidant in separate locations. This conjugate was synthesized by stepwise conjugation reactions of native chymotrypsin first with oligo(HBMA)-COONHS and then with Trolox-NHS. MALDI-TOF spectra demonstrate that the first modification of native chymotrypsin increases molecular weight from 25,187 Da to 26,400 Da. Thus, at least 2 molecules of oligo(HBMA) are present on each molecule of the enzyme after the first modification (FIGS. 3A and 3B). Repeating the reaction of this modified product with Trolox-NHS increased the molecular weight further to 27,950 Da, representing further modification with 6 more Trolox molecules (FIG. 3C). The synthesis of CTM-separate is described in detail in FIG. 4. Trolox equivalent antioxidant capacity (TEAC) of CTM-separate was found to be 0.3 mM. Thus, as further described in the Experimental section below one third of the original intrinsic antioxidant activity of free Trolox was retained after its conjugation with the enzyme. An ABTS discoloration assay confirmed that neither native chymotrypsin nor chymotrypsin-oligo(HBMA) exhibited antioxidant activity.

As shown in the FIG. 1B, CTM-single is the conjugate in which chymotrypsin is modified with a single chain comprising both the UV-absorber and the antioxidant. FIG. 4 summarizes the synthetic strategy used to obtain first the single chain oligo(HBMA-co-Trolox-HEMA)-COOH and its conjugate with chymotrypsin (CTM-single). MALDI-TOF spectra showed conjugation of 1-2 chains of the co-oligomer per molecule of native chymotrypsin (FIG. 3 (d); m/z=27,650). CTM-single also retained one third of the original intrinsic antioxidant activity of free Trolox (TEAC=0.33 mM). The modified enzymes retained >90% activity of native chymotrypsin as determined from an end point activity assay of hydrolysis of N-succinyl-Ala-Ala-Pro-Phe-p-nitroanilide.

When an aqueous mixture of chymotrypsin and an excess of water soluble copolymer of Trolox-HEMA and HBMA (M.W. ˜30,000 Da) was exposed to TiO₂-UV enzyme activity ceased in just 3 hrs. Previously, it has been shown in the chymotrypsin —TiO₂ system, that 80% of the enzyme adsorbs onto TiO₂ within the first two hours of stirring the enzyme-TiO₂ suspension under the conditions used. Lele, B. S.; Russell, A. J. Biomacromolecules 2004, 5, 1947-1955. Thus, excited TiO₂ is always in contact with the enzyme and for a stabilizing agent to be most effective it has to be covalently attached to the enzyme.

Enzyme stability against photoexcited TiO₂ can also be increased by addition of electron acceptor e.g. oxygen purging and/or hole acceptor e.g. methanol or formic acid. We measured the stability of native chymotrypsin against TiO₂-UV in the presence of oxygen and 10% v/v methanol, respectively. In both the cases there was a slight increase in enzyme stability, however, this was not significant when compared with the stability of UV and free radical-absorbing CTM-single. Since these additives are not specific to the active site of enzyme bound to TiO₂ it is not surprising that the stabilization was less dramatic.

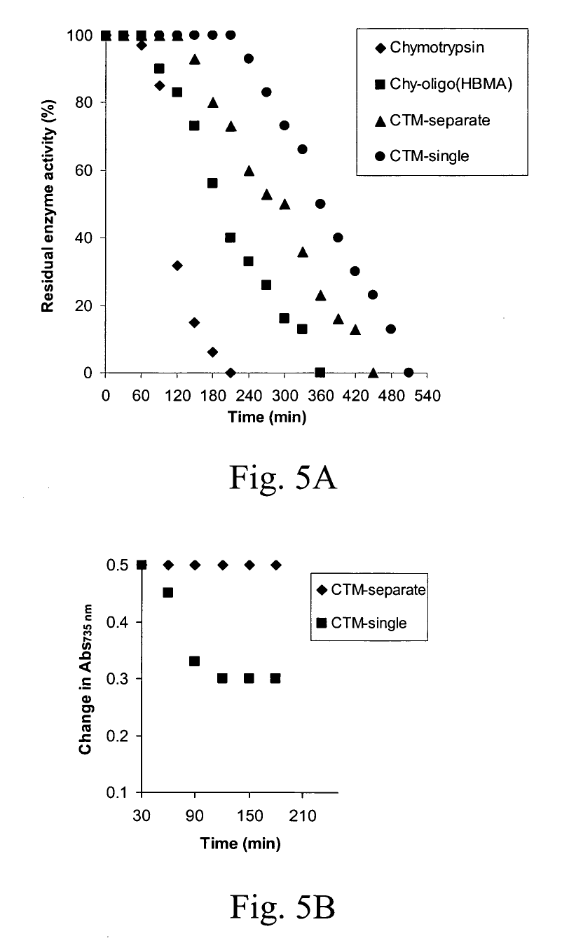

FIG. 5A shows the data for activity retention of the modified enzymes synthesized as described above, upon their exposure to TiO₂-UV. As reported previously, native unprotected chymotrypsin loses all its activity within 3 hrs. The short lag in activity loss is believed to be a result of the non-specific oxidation of the enzyme that occurs before the active site is damaged sufficiently to impair the enzyme activity. The chymotrypisn-oligo(HBMA) with no antioxidant activity had a significantly decreased rate of eventual inactivation, but, importantly, the length of the lag phase was not increased. CTM-separate, however, exhibits an almost doubled inactivation lag phase during exposure to TiO₂-UV. After the lag phase the rate of inactivation was not slowed. In the case of CTM-single the inactivation lag phase is further increased to four hrs of exposure to TiO₂-UV. After this marked enhancement in the lag phase stability, the subsequent rate of inactivation was not decreased. Thus, CTM-single exhibited a significantly higher stabilization impact than CTM-separate under photooxidizing conditions.

In addition to understanding post-modification enzyme activity, it is also desirable to understand whether the intrinsic activity of Trolox was altered by attachment to the protein macromolecule. CTM-separate had 6 molecules of conjugated Trolox and CTM-single had 4 molecules of conjugated Trolox per molecule of the native enzyme. Also, both of the modified enzymes had similar capacities to absorb free radicals (TEAC=0.3 mM). Since Trolox was equally active in each form, though less active than in free solution, the increased enzyme stability that we observed when adding Trolox and HBMA in the same chain must have been caused by co-localization and not changes in Trolox intrinsic activity.

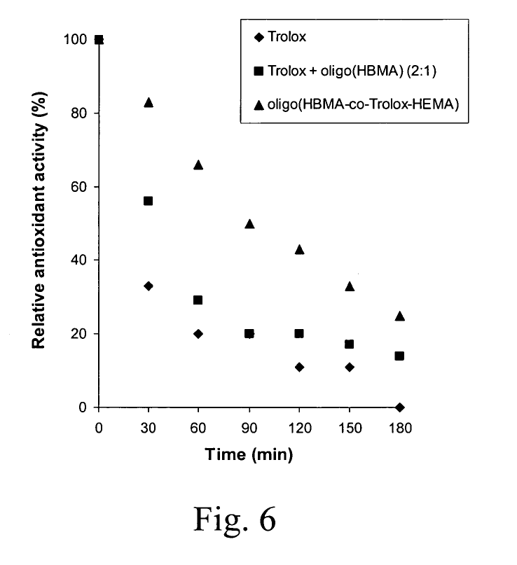

TiO₂-UV caused no intrinsic loss in the antioxidant activity of CTM-single (FIG. 5B). Interestingly, a 50% loss in antioxidant activity of CTM-separate was observed during exposure to TiO₂-UV. These results suggest a hypothesis as shown in FIG. 1A that in the absence of adjacent or co-localized HBMA, Trolox is readily degraded by TiO₂-UV. To investigate further whether the co-localization (for example, single chain) approach is important in protecting Trolox from the photooxidation, we measured the free radical absorbing activity of Trolox exposed to TiO₂-UV in the free and in the single-chained co-oligomeric form. Data in FIG. 6 showed that free Trolox lost 80% activity during the first hour of photooxidation. However, in the co-oligomeric form, deactivation of Trolox was significantly reduced. A potential mechanism to explain the significant reduction is the UV-absorption by adjacent HBMA and reduction in the excitation of TiO₂ in its vicinity. These data support enhanced enzyme stabilization via a co-localized (for example, single chain) modification approach which enables absorption of free radicals by the antioxidant for a longer duration than that by the separate chain modification approach as shown in FIGS. 1A and 1B.

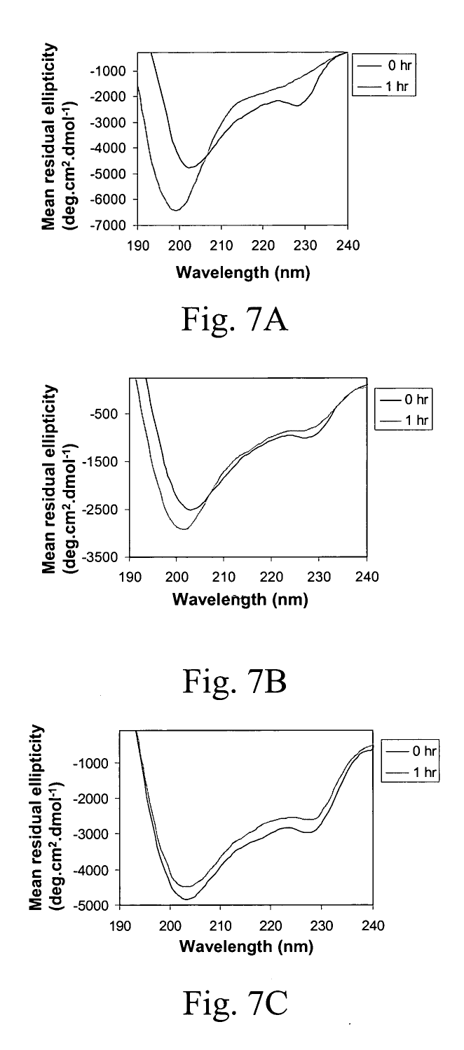

Another iportant issue is how TiO₂-UV inactivates enzyme and how the UV-absorber and antioxidants protect the enzyme. Changes in the secondary structure of proteins during inactivation can be observed by circular dichroism (CD). TiO₂-UV induces two distinct changes in the secondary structure of native chymotrypsin. Lele, B. S.; Russell, A. J. Biomacromolecules 2004, 5, 1947-1955. FIGS. 7A-7C illustrate CD spectra of native and modified chymotrypsins exhibiting different levels of resistance to changes in the secondary structure caused by TiO₂-UV for Native chymotrypsin; CTM-separate and CTM-single. respectively. The first change is the perturbation and degradation of tryptophan residues as reflected in the disappearance of the characteristic minimum at 230 nm and the second change is the transition towards random coil formation as reflected in the blue shift in the peak at 202 nm (FIG. 7A). After exposure to TiO₂-UV, CTM-single exhibited minimal changes in its secondary structure (FIGS. 7B and 7C). These data show that the prolonged absorption of UV-light and free radicals by the conjugated co-oligomer gave enhanced protection to the enzyme's secondary structure against harmful effects of photooxidation. Studies involving stabilities of glucose oxidase and horseradish peroxidase under TiO₂-UV irradiation have pointed to the hydroxyl radicals as the main species that inactivates the enzyme. See Ganadu, M. L.; Andreotti, L.; Vitali, I.; Maldotti, A.; Molinari, A.; Mura, G. M. Photochem. Photobiol. Sci. 2002, 1, 951-954 and Hancock-Chen, T.; Scaiano, J. C. J. Photochem. Photobiol. B: Biol. 2000, 57, 193-196. Degradation of tryptophan residues in chymotrypsin by the free radicals generated from TiO₂-UV have also been described. Lele, B. S.; Russell, A. J. Biomacromolecules 2004, 5, 1947-1955. The co-localization (for example, single chain) modification strategy can remove these radicals effectively since the antioxidant is temporarily protected.

In summary, representative studies of several embodiments of the present invention demonstrated enhanced the stability of a model enzyme, chymotrypsin, to photooxidation caused by TiO₂-UV by conjugating the enzyme with oligomeric adducts of UV-absorbing HBMA and free radical absorbing Trolox-HEMA. Without limitation to any mechanism of operation, it is believed that enhanced enzyme stability originates from the ability of HBMA moieties to absorb UV light/energy and reduce the excitation of TiO₂ and thereby protect the antioxidant activity of adjacent Trolox moieties. This allows the representative single-chain-modified enzyme to absorb free radicals for longer without harming the enzyme during photooxidation. Both the antioxidant and the UV-absorber were eventually oxidized by TiO₂-UV, followed by enzyme deactivatoon. However, the modified enzyme systems studied in the present invention were not optimized. Nonetheless, a stabilization effect of up to 4 hrs was been induced by only two molecules of oligomeric modifiers conjugated to the enzyme. Extended enzyme stability against the photooxidative degradation is, for example, achievable by either increasing the degree of modification or by conjugating high molecular weight copolymers of antioxidant and UV-absorber to the enzyme. Enhancing stability of enzyme against photooxidation is, for example, particularly useful in developing bio-inorganic hybrid materials for decontamination applications. For example, the modified enzyme systems of the present invention can be used in protective coatings that simultaneously use photocatalysis and biocatalysis to decontaminate organophosphates.

### Experimental

Materials: α-Chymotrypsin (from bovine pancreas), N-succinyl-Ala-Ala-Pro-Phe-p-nitroanilide, sodium deoxycholate, N-hydroxysuccinimide (NHS), sodium phosphate (Na₂HPO₄), bicinchoninic acid solution, copper (II) sulfate solution, bovine serum albumin protein standards, potassium persulfate and 2,2′-azinobis-(3-ethylbenzothiazoline-6-sulfonic acid) diammonium salt (ABTS, 1.8 mM) were purchased from Sigma Co. (Saint Louis, Mo.). HBMA, Trolox (6-hydroxy-2,5,7,8-tetramethylchroman-2-carboxylic acid), 2-hydroxyethyl methacrylate (HEMA), 1,3-(dimethylaminopropyl)-3-ethylcarbodiimide.hydrochloride (EDC), 1,3-dicyclohexylcarbodiimide (DCC), 4,4′-azobis(cyanovaleric acid), anhydrous tetrahydrofuran (THF), anhydrous N,N-dimethylformamide (DMF), dichloromethane, n-hexane and dioxane were purchased from Aldrich Chemical Company (Milwaukee, Wis.). Centrifugal dialysis-filtration tubes (Centricon® Plus-20) with 10,000 Da molecular weight cut off (MWCO) were purchased from Millipore Co. (Bedford, Mass.). TiO₂ (Degussa P25) was obtained from Degussa A.G., Frankfurt, Germany.

Methods

NMR spectroscopy: ¹H-NMR spectra of oligomeric modifiers were recorded on a Bruker spectrometer operating at 300 MHz.

ESI-APCI mass spectroscopy: Molecular weights of oligomeric modifiers were determined using Finnigan LCQ quadrupole field ion trap mass spectrometer with electrospray ionization (ESI) and atmospheric pressure chemical ionization (APCI) sources. Samples were dissolved in dichloromethane (1 mg/mL) and injected into the ionization chamber of the spectrometer.

MALDI-TOF spectrometry: Modified enzymes were characterized by analyses performed on a Perseptive Biosystems Voyager elite MALDI-TOF. The acceleration voltage was set at 20 kV in a linear mode. Enzyme solution (0.5-1.0 mg/mL) was mixed with an equal volume of matrix (0.5 mL water, 0.5 mL acetonitrile, 2 μL trifluoroacetic acid and 8 mg α-cyano-4-hydroxycinnamic acid) and 2 μL of the resulting mixture were spotted on the plate target. Spectra were recorded after solvent evaporation.

CD spectroscopy: At 60 min intervals, 0.3 mL aliquots were removed from UV-irradiated enzyme-TiO₂ suspensions and filtered through 0.2 μm filters. Protein solutions were diluted to obtain concentrations of 0.1 mg/mL. 400 μL of the sample (0.1 mg/mL) were placed in a quartz cuvette (path length, 1 mm) inside an Aviv CD spectrometer (model 202). Each spectrum was accumulated by averaging 10 scans between 190 to 260 nm. All spectra were corrected for background signals of the buffer. Mean residual ellipticity ([θ]_{λ} deg.cm².dmol⁻¹) values were obtained from θ_{observed} using the equation (1).
[θ]_{λ}=θ_{observed}·M_{w}/10*(l.c.n)
Where, M_{w} is the molecular weight of chymotrypsin, 1 is the path length (0.1 cm), n is the total number of amino acid residues in chymotrypsin (241) and c is the concentration (g/mL).

Exposure of enzymes to UV-irradiated TiO₂: Enzyme (0.8 mg protein/mL, total 10 mL in 25 mM phosphate buffer, pH 7.5) was placed in an open scintillation vial. TiO₂ fine powder (0.25 mg/mL) was added to the protein solution and the suspension was stirred gently at room temperature (25° C.) with a magnetic stir bar placed inside the vial. The enzyme-TiO₂ suspension was placed under a BLAK-RAY® longwave UV lamp (model No. B-100AP, UVP, San Gabriel, Calif.). The distance between the UV lamp and the vial was 18 cm. At this distance, the UV irradiance at 365 nm (λₘₐₓ) was 8 mW/cm² (determined using a BLAK-RAY® UV meter (Model No. J-221). It was also verified that there was no thermal denaturation of the enzyme during irradiation and the temperature of the enzyme-TiO₂ suspension remained constant (25±2° C.) throughout.

Determination of the residual enzyme activity: Measurable loss in enzyme activity was observed at 30 min intervals. At 30 min intervals, 100/L aliquots were removed from the irradiated enzyme-TiO₂ suspension and added to 1.2 mL of N-succinyl-Ala-Ala-Pro-Phe-p-nitroanilide solution (0.5 mg/mL in 25 mM phosphate buffer, pH 7.5). The enzyme to substrate concentration ratio was 3.4 μM: 800 μM. After 1 min, the TiO₂-enzyme-substrate suspension was filtered through a 0.2 μm filter and the absorbance of hydrolyzed p-nitroaniline measured at 412 nm using a Perkin-Elmer spectrophotometer (model Lambda 45). Hydrolysis of the substrate by the buffer was negligible during the assay time. Original activities of native and modified chymotrypsins were also determined as described above. It was also confirmed that TiO₂ alone did not cause hydrolysis of the substrate.

Exposure of antioxidants to UV-irradiated TiO₂: Trolox (0.01 mg/mL) was dissolved in 10 mL phosphate buffer (25 mM, pH 7.5). TiO₂ (0.25 mg/mL) was added to the Trolox solution. The suspension was stirred and irradiated with UV as described above. At 30 min intervals, 1 mL aliquots were removed from the irradiating suspension and filtered through a 0.2 μm filter. Oligo(HBMA-co-Trolox-HEMA)-COOH (0.03 mg/mL) or a physical mixture of oligo(HBMA)-COOH (0.01 mg/mL) and Trolox (0.02 mg/mL) were dissolved in a 50:50 binary solvent mixture of DMF and phosphate buffer (25 mM, pH 7.5). TiO₂ (0.25 mg/mL) was added to these solutions, irradiated with UV and aliquots filtered as described above.

Determination of residual antioxidant activity: Antioxidant activities of modified enzymes and the modifiers were measured according to the following modification of the assay reported by Re et al. Re, R.; Pellegrini, N.; Proteggente, A.; Pannala, A.; Yang, M.; Rice-Evans, C. Free Rad. Biol. Med. 1999, 9/10, 1231-1237. This assay is based on the principle of discoloration of pre-formed blue ABTS⁺ radical (λₘₐₓ 734 nm) due to its quenching by the addition of the antioxidant. Equal volumes of ABTS (1.8 mM) and potassium persulfate (0.63 mM) were mixed together and kept in the dark for 16 hrs at 25° C. to obtain a stable blue colored ABTS⁺ radical. The ABTS⁺ solution was diluted four times to obtain an absorbance of 0.6 at 734 nm. Equal volumes (0.5 mL) of ABTS⁺ and TiO₂-UV exposed enzyme solution (0.8 mg protein/mL) were mixed together. The change in absorbance at 734 nm was recorded 1 min after the mixing. Similarly, 0.5 mL of TiO₂-UV exposed Trolox or oligo(HBMA-co-Trolox-HEMA)-COOH solutions were mixed with 0.5 mL of ABTS⁺ and the residual antioxidant activity was then measured. Trolox equivalent antioxidant capacities (TEAC) (defined as the antioxidant activity of 1 mM modified enzyme equivalent to that of the 1 mM free Trolox) were calculated using the standard plot created for the concentration of Trolox versus the change in absorbance of ABTS⁺.

Synthesis of 2-methacryloyloxyethyl-(6-hydroxy-2,5,7,8-tetramethylchroman-2-carboxylate) (Trolox-HEMA). In a 500 mL capacity round bottom flask, Trolox (2.5 g, 10 mmol) and HEMA (1.31 g, 10 mmol) were dissolved in 200 mL anhydrous THF. EDC (3.0 g, 15 mmol) was added and the reaction mixture was stirred at 25° C. for 16 hrs. The reaction mixture was filtered to remove urea salts and concentrated to 100 mL under vacuum. The concentrated solution was poured in IL cold water (4° C.). The product precipitated as white powdery material upon standing in the refrigerator for 1 hr and triturating with hexane. The product was washed with water and isolated as a single spot compound (TLC in 80:20 hexane:ethyl acetate). Yield 1 g (27%). ¹H-NMR (CDCl₃): 1.5 δ 3H singlet (—CH₃ of chroman ring), 1.75 δ 3H singlet (—CH₃—C═C— of HEMA), 2.2 δ 9H multiplate (—CH₃ of substituted phenol moiety in Trolox), 2.4 δ 2H triplet (-Ph-CH₂—CH₂—C—O— of chroman ring in Trolox), 2.6 δ 2H (-Ph-CH₂—CH₂—C—O— of chroman ring in Trolox), 3.9 δ 2H (—O—CH₂—CH₂—O—COO— of HEMA), 4.3 δ 2H (—O—CH₂—CH₂—O—COO— of HEMA), 5.5 δ singlet 1H (—C═C—Hₐ of HEMA), 6.2 δ singlet 1H (—C═C—H_{b} of HEMA).

Synthesis of oligo(HBMA-co-Trolox-HEMA)-COOH. In a three necked round bottom flask equipped with a reflux condenser, HBMA (0.88 g, 2.75 mmol), Trolox-HEMA (0.90 g, 2.75 mmol) and 4,4′-azobis(cyanovaleric acid) (0.077 g, 0.275 mmol) were dissolved in 30 mL DMF. Nitrogen gas was purged through the DMF solution for 30 minutes at room temperature. Polymerization was conducted at 80° C. for 12 hrs under the continuous purging of nitrogen. Oligo(HBMA-co-Trolox-HEMA)-COOH was isolated by precipitation of the DMF solution into 1 L distilled water (pH 1.5). The product was purified by first extraction in acetone and then reprecipitation from dichloromethane into n-hexane. Yield 1 g (56%). ¹H-NMR (CDCl₃): 0.8 δ singlet (—CH₂—C—CH₃ of polymer backbone), 1.5-1.7 δ multiplate (—CH₂—C—CH₃ of polymer backbone), 2.0-2.2 δ multiplate (—CH₃ of substituted phenol moiety in Trolox), 2.5-3.0 δ multiplate (benzyl —CH₂— of HBMA+Ph-CH₂—CH₂— of chroman ring in Trolox), 4.0-4.4 δ multiplate (—COO—CH₂—CH₂— of hydroxyethyl spacers in HBMA and Trolox), 7.0-8.3 δ multiplate (aromatic protons of HBMA), 11.2 δ singlet (phenolic-OH of HBMA and Trolox). Molecular weight=1192 (ESI/APCI mass spectrometry).

Synthesis of oligo(HBMA)-COOH. In a three necked round bottom flask equipped with a reflux condenser, HBMA (4.0 g, 12 mmol) and 4,4′-azobis(cyanovaleric acid) (0.34 g, 1.2 mmol) were dissolved in 40 mL DMF. Nitrogen gas was purged through the DMF solution for 30 minutes at room temperature. Polymerization was conducted at 80° C. for 12 hrs under the continuous purging of nitrogen. Oligo(HBMA)-COOH was isolated by precipitation of the DMF solution into 1 L distilled water (pH 1.5). The product was purified by reprecipitation from dichloromethane into n-hexane. Yield 2 g (50%). ¹H-NMR (CDCl₃): 1.0-2.0 δ broad multiplate (—CH₂—C—CH₃ of polymer backbone), 3.0 δ singlet (benzyl —CH₂ of HBMA), 4.1 δ singlet (—COO—CH₂—CH₂—O— of hydroxyethyl spacer in HBMA), 7.0-8.7 δ multiplate (aromatic protons of HBMA), 11.2 δ singlet (phenolic —OH of HBMA). Molecular weight=772 (ESI/APCI mass spectrometry).

Synthesis of NHS esters. A typical procedure for the synthesis of oligo(HBMA-co-Trolox-HEMA)-COONHS is described in the following. One gram oligo(HBMA-co-Trolox-HEMA)-COOH was dissolved in 20 mL dichloromethane and five fold molar excesses of NHS and DCC were added to the dichloromethane solution. The reaction mixture was stirred for 16 hrs at 25° C. and filtered to remove dicyclohexyl urea. The clear solution was poured into 500 mL n-hexane under stirring to precipitate the product. The product was purified by re-precipitation from dichloromethane into n-hexane. Yield 0.6 g (60%). Trolox-NHS and oligo(HBMA)-COONHS were synthesized in a similar fashion.

Synthesis of “CTM-single” (chymotrypsin modified with oligo(HBMA-co-Trolox-HEMA). α-Chymotrypsin (100 mg) was dissolved in phosphate buffer (20 mL of 160 mM, pH 8.8) containing 0.8% w/w sodium deoxycholate. Oligo(HBMA-co-Trolox-HEMA)-COONHS (200 mg) was dissolved in anhydrous dioxane (2 mL) and added to the chymotrypsin solution under stirring. The reaction mixture was stirred at 25° C. for 2 hrs and filtered through 0.45 μm filter to remove the precipitated oligo(HBMA-co-Trolox-HEMA)-COOH. The clear solution was lyophilized to remove dioxane. Lyophilized powder containing the enzyme and salts was dissolved in 50 mL phosphate buffer (25 mM, pH 7.5). The enzyme solution was placed in centrifugal dialysis-filtration tubes (Centricon® Plus-20; 10,000 Da MWCO) and centrifuged at 4,000 rpm for 15 minutes. The concentrated retentate was diluted to 20 mL with phosphate buffer (25 mM, pH 7.5) and dial-filtered again as described above. The amount of conjugate obtained was estimated by bicinchoninic acid protein assay. Yield 20-30%.

Synthesis of “CTM-separate” (chymotrypsin modified with oligo(HBMA) and Trolox). The conjugate was synthesized in two steps. In the first step, α-chymotrypsin (100 mg) was reacted with oligo(HBMA)-COONHS (200 mg). Purified chymotrypsin-oligo(HBMA) (100 mg) was reacted with Trolox-NHS (100 mg) as described above. Yield 20-30%.

The foregoing description and accompanying drawings set forth the preferred embodiments of the invention at the present time. Various modifications, additions and alternative designs will, of course, become apparent to those skilled in the art in light of the foregoing teachings without departing from the scope of the invention. The scope of the invention is indicated by the following claims rather than by the foregoing description. All changes and variations that fall within the meaning and range of equivalency of the claims are to be embraced within their scope.

What is claimed is:

1. A composition comprising at least one antioxidant moiety and at least one UV-absorbing moiety, the antioxidant moiety and the UV-absorbing moiety being maintained in proximity to each other.

2. The composition of claim 1 wherein the antioxidant moiety and the UV-absorbing moiety are covalently attached within a single molecule.

3. The composition of claim 1 wherein the UV-absorbing moiety and the antioxidant moiety are attached to a common entity.

4. The composition of claim 3 wherein the UV-absorbing moiety is attached sufficiently closely to the antioxidant moiety to enhance the stability of the antioxidant in an environment in which photooxidation can occur.

5. The composition of claim 2 wherein the UV-absorbing moiety is attached within the molecule sufficiently closely to the antioxidant moiety to enhance the stability of the antioxidant in an environment in which photooxidation can occur.

6. The composition of claim 5 wherein the UV-absorbing moiety is attached to the molecule to be juxtapositioned to the antioxidant moiety.

7. The composition of claim 5 wherein the UV-absorbing moiety and the antioxidant moiety are attached to a single polymeric chain.

8. The composition of claim 7 wherein the polymeric chain is formed by reaction of at least a first monomer incorporating the UV-absorbing moiety and a second monomer incorporating the antioxidant moiety.

9. The composition of claim 7 wherein the polymeric chain is formed by reacting a polymeric precursor with a first compound incorporating the UV-absorbing moiety and a second compound incorporating the antioxidant moiety.

10. The composition of claim 5 wherein the single molecule is added to a material to stabilize the material.

11. The composition of claim 10 wherein the single molecule is physically mixed with the material or attached to the material.

12. The composition of claim 11 wherein the single molecule is covalently attached to the material.

13. The composition of claim 10 wherein the material is a polymeric material.

14. The composition of claim 10 wherein the material is a cosmetic.

15. The composition of claim 10 wherein the material is a sun screen.

16. The composition of claim 10 wherein the material is a protein.

17. The composition of claim 10 wherein the material is an enzyme.

18. The composition of claim 10 wherein the enzyme is supported on a free radical producing support.

19. The composition of claim 18 wherein the support comprises at least one species which is a photocatalytic oxidant.

20. The composition of claim 19 wherein the enzyme is adsorbed on a particle of titanium dioxide.

21. The composition of claim 1 where the least one antioxidant moiety and the at least one UV-absorbing moiety are tethered to be localized.

22. A method of stabilizing an antioxidant moiety comprising the step of maintaining at least one UV-absorbing moiety sufficiently closely to at least one antioxidant moiety to enhance the stability of the antioxidant moiety in an environment in which photooxidation can occur.

23. The method of claim 23 wherein the least one antioxidant moiety and the at least one UV-absorbing moiety are attached to a common entity.

24. The method of claim 24 wherein the antioxidant moiety and the UV-absorbing moiety are covalently attached to a single molecule.

25. The method of claim 25 wherein the UV-absorbing moiety is attached to the molecule to be juxtapositioned to the antioxidant moiety.

26. The method of claim 25 wherein the UV-absorbing moiety and the antioxidant moiety are attached to a single polymeric chain.

27. The method of claim 27 wherein the polymeric chain is formed by reaction of at least a first monomer incorporating the UV-absorbing moiety and a second monomer incorporating the antioxidant moiety.

28. The method of claim 27 wherein the polymeric chain is formed by reacting a polymeric precursor with a first compound incorporating the UV-absorbing moiety and a second compound incorporating the antioxidant moiety.

29. A composition comprising at least one antioxidant moiety and at least one UV-absorbing moiety, the antioxidant moiety and the UV-absorbing moiety being covalently attached within a single molecule wherein the UV-absorbing moiety is attached sufficiently closely to the antioxidant moiety to enhance the stability of the antioxidant in an environment in which photooxidation can occur.

30. A method of adding an antioxidant to a material comprising the step of adding to the composition an antioxidant composition comprising at least one antioxidant moiety and at least one UV-absorbing moiety, the antioxidant moiety and the UV-absorbing moiety being covalently attached within a single molecule wherein the UV-absorbing moiety is attached sufficiently closely to the antioxidant moiety to enhance the stability of the antioxidant in an environment in which photooxidation can occur.

31. The method of claim 31 wherein the antioxidant composition is mixed into the material.

32. The method of claim 31 wherein the antioxidant composition is attached to a component of the material.

33. The method of claim 33 wherein the antioxidant composition is covalently bonded to the component of the material.

34. The method of claim 31 wherein the material is a polymer, a cosmetic, or a sun screen.

35. The method of claim 31 wherein the material is a protein,

36. The method of claim 36 wherein the material is an enzyme.
